(19) United States
(12) Patent Application Publication
(10) Pub. No.: US 2003/0106788 A1
(43) Pub. Date: Jun. 12, 2003

(54) Non-thermal plasma slit discharge apparatus

(76) Inventor: Sergei Babko-Malyi, West Windsor, NJ (US)

Correspondence Address: DARBY & DARBY P.C., Post Office Box 5257, New York, NY, 10150-5257, US

(21) Appl. No.: 10/287,772

(22) Filed: Nov. 4, 2002

Related U.S. Application Data
(60) Provisional application No. 60/336,866, filed on Nov. 2, 2001.

(51) Int. Cl. B01J 19/08

(52) U.S. Cl. 204/164; 423/240 R; 422/186

(57) ABSTRACT

A non-thermal atmospheric pressure plasma reactor including a primary dielectric having at least one slit defined therein and a segmented electrode including a plurality of electrode segments. Each electrode segment disposed proximate and in fluid communication with an associated slit. The slit in the dielectric may be formed in any number of ways such as a plurality of slits defined in a substantially planar dielectric plate. Other configurations include a plurality of dielectric segments (e.g., bars, slabs, rings, annular sections) assembled together so that a slit is formed between adjacent dielectric segments. In operation a voltage differential is applied between the segmented electrode and a receiving electrode disposed proximate the primary dielectric to produce a plasma discharge. The plasma discharge is emitted through the slits in the primary dielectric. This inventive plasma discharge device configuration produces a relatively high density non-thermal plasma discharge of relatively large volume yet is relatively easy and inexpensive to manufacture.

### CROSS-REFERENCE TO RELATED APPLICATIONS

This application claims the benefit of U.S. Provisional Application No. 60/336,866, filed on Nov. 2, 2001, which is hereby incorporated by reference in its entirety.

### BACKGROUND OF THE INVENTION

1. Field of the Invention

The present invention is directed to an apparatus for generating a non-thermal plasma discharge through slits or perforations in a dielectric material, and a method for using the same.

2. Description of Related Art

A “plasma” is a partially ionized gas composed of ions, electrons, and neutral species. This state of matter is produced by relatively high temperatures or relatively strong electric fields either constant (DC) or time varying (e.g., RF or microwave) electromagnetic fields. Discharged plasma is produced when free electrons are energized by electric fields in a background of neutral atoms/molecules. These electrons cause electron atom/molecule collisions which transfer energy to the atoms/molecules and form a variety of species which may include photons, metastables, atomic excited states, free radicals, molecular fragments, monomers, electrons, and ions. The neutral gas becomes partially or fully ionized and is able to conduct currents. The plasma species are chemically active and/or can physically modify the surface of materials and may therefore serve to form new chemical compounds and/or modify existing compounds. Discharge plasmas can also produce useful amounts of optical radiation to be used for lighting. Many other uses for plasma discharge are available.

Heretofore, discharges at atmospheric pressure were stabilized by applying geometrically in homogenous electrode configurations such as point-to-plane or wire-to-cylinder. Such conventional configurations created a zone with high electric field strength near the smaller electrode and relatively large zone with lower electric field strength in the region proximate the larger electrode.

U.S. patent application Ser. No. 09/738,923, filed on Dec. 15, 2000, discloses a non-thermal atmospheric pressure plasma discharge device configured with a plurality of capillaries defined in the primary dielectric and segmented electrodes disposed proximate and in fluid communication with an associated capillary. A capillary is defined as an aperture, hole or opening enclosed on all sides (except for a top and bottom opening) having a perimeter defined by substantially radial walls, wherein the lateral cross section of the capillary has substantially equal length and width. This plasma discharge device is complex and thus relatively expensive to manufacture.

It is desirable to develop an improved non-thermal atmospheric pressure plasma discharge device that may be easily and less costly to manufacture while still producing a relatively high current density per unit of electrode area and a substantially homogeneous distribution of current through the space and over the area of the electrode.

### SUMMARY OF THE INVENTION

For the purposes of this invention, the term “slit” will be defined as an perforation, opening, aperture, hole, groove or channel having a lateral cross section in which its width is smaller than its length. The slit is not required to have closed walls on all sides and thus includes any passage or channel that has at least one open ended side (in addition to a top and bottom opening).

The present invention solves the aforementioned problems associated with conventional plasma generation devices by developing an improve non-thermal atmospheric pressure plasma discharge device having a slit or perforated dielectric configuration.

The present inventive non-thermal atmospheric plasma discharge device produces a higher current density per unit of electrode area and more homogeneous distribution of current through the space and over the area of the electrode.

In addition, the present invention non-thermal atmospheric plasma discharge device is more readily manufactured.

### BRIEF DESCRIPTION OF THE DRAWING

FIG. 1a is a perspective view of an exemplary first embodiment of a non-thermal atmospheric pressure plasma discharge device in accordance with the present invention, wherein a dielectric plate has a plurality of slits defined therein with electrode blades disposed substantially parallel to the respective slits;

FIG. 1b is a top view of the primary dielectric plate with the slits defined therein of FIG. 1a;

FIG. 2 is a perspective view of an exemplary second embodiment of a non-thermal atmospheric pressure plasma discharge device in accordance with the present invention, wherein a plurality of dielectric rods are assembled together with a slit formed between adjacent rods and electrode blades disposed substantially perpendicular to the respective slits;

FIG. 3a is a bottom view of an exemplary third embodiment of a non-thermal atmospheric pressure plasma discharge device in the accordance with the present invention;

FIG. 3b is a side view of the plasma discharge device of FIG. 3a;

FIG. 4a is a perspective view of an exemplary fourth embodiment of a non-thermal atmospheric pressure plasma discharge device in accordance with the present invention, with a portion of the primary dielectric cut away to expose the primary electrode;

FIG. 4b is a lateral cross-sectional view of the plasma discharge device of FIG. 4a;

FIG. 4c is a longitudinal cross-sectional view of the plasma discharge device of FIG. 4a;

FIG. 4d is an enlarged view illustrating the intensity of the plasma discharge concentrated about the saw tooth edges of the primary electrode in FIG. 4a;

FIG. 5a is a side view of an exemplary arrangement of a plurality of U-shaped dielectric slit configuration non-thermal atmospheric pressure plasma discharge devices of FIG. 4a arranged on a rotating central wheel;

FIG. 5b is a top view of an exemplary arrangement of a two U-shaped dielectric slit configuration non-thermal atmospheric pressure plasma, discharge devices of FIG. 4a mounted substantially perpendicular with respect to one another and the assembly is rotatable relative to fixed receiving electrodes;

FIG. 5c is a cross-sectional view of an exemplary arrangement of stacking of U-shaped dielectric slit configuration non-thermal atmospheric pressure plasma discharge devices of FIG. 4a;

FIG. 6a is a perspective view of a fifth exemplary embodiment of a non-thermal atmospheric pressure plasma discharge device having a plurality of dielectric rods arranged to form slits therebetween, a portion of the dielectric rods is cut away to reveal the configuration of the inner cylindrical tube; and

FIG. 6b is a side view of an exemplary arrangment of a plurality of non-thermal atmospheric pressure plasma discharge devices, each configured with a plurality of dielectric rods arranged to form slits therebetween and a receiving electrode plate disposed between adjacent plasma discharge devices.

### Detailed Description of the Invention

FIG. 1a is an exemplary embodiment of the non-thermal atmospheric pressure plasma discharge device having a slit dielectric configuration in accordance with the present invention. A primary dielectric plate 11 has one or more slits 13 defined therein, as shown in the top view in FIG. 1b. The slits 13 shown in FIG. 1b are rectangular in shape, however, other geometrical configurations are contemplated and within the intended scope of the invention. By way of illustrative example, three slits are shown but any number of one or more slits may be employed and the orientation of the slits may be varied, as desired. When a plurality of slits are employed, each slit may, but need not necessarily be, of the same size and geometric shape. A segmented electrode 12 is disposed substantially parallel, proximate and in fluid communication with an associated slit 13. Alternatively, the segmented electrode 12 may be disposed substantially perpendicular relative to the respect slits. In the example shown in FIG. 1a, the segmented electrode is a plurality of electrodes each in the shape of a blade, however, other configurations are contemplated such as a wire or wedge. Preferably, the blade has a tapered edge or saw tooth edge to concentrate the high electric field so as to produce a plasma discharge. Although not shown in the embodiment in FIG. 1a, the segmented electrodes 12 may be partially or fully inserted into the respective slits 13. The segmented electrodes are connected to a high voltage power supply 10 with a voltage differential applied therebetween.

A receiving electrode 16 is disposed separated from the primary dielectric 11 so as to form a channel 19 therebetween through which a reagent fluid to be treated is received. The receiving electrode 16 is also connected to the power source and may be covered with a secondary dielectric 15 disposed on the surface of the receiving electrode 16 proximate the primary dielectric 11, in the case in which an AC or RF power source 10 is used. However, if a DC power source 10 is employed then the secondary dielectric 15 is omitted so as to allow for a clear conducting path between the segmented and receiving electrodes 12, 16.

In operation the reagent fluid, e.g., gas to be treated, is passed through the channel 19 formed between the primary dielectric 11 and secondary dielectric 15. A voltage differential is applied between the segmented electrodes 12 and receiving electrode 16 to generate a plasma discharge that is directed by the slits 13 into the channel 19 towards the receiving electrode 16.

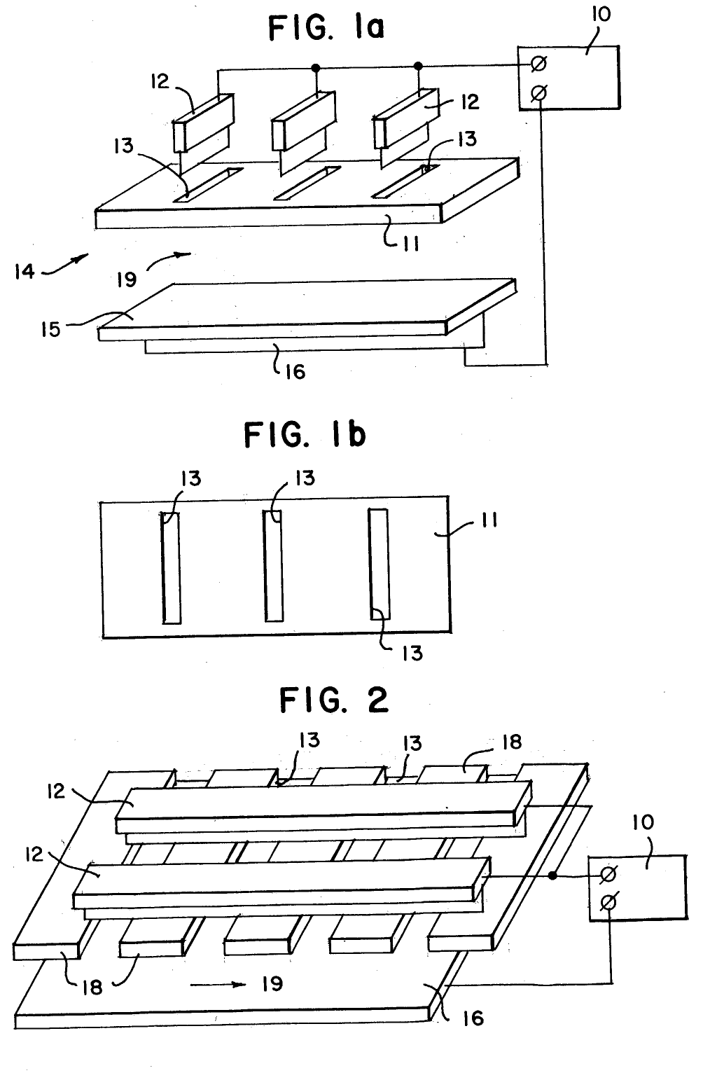

FIG. 2 is an alternative embodiment of the plasma discharge device shown in FIG. 1a wherein instead of a single dielectric plate have a plurality of slits defined therein, a plurality of dielectric rods or bars 18 are assembled together with a slit 13 formed between adjacent rods. The dielectric rods may be secured together by a wire or other conventional means so that opposing sides of the slits defined between adjacent rods remain open ended. In contrast to the embodiment shown and described above with respect to FIG. 1a and 1b, by way of illustration the electrode blades 12 in the embodiment shown in FIG. 2 are arranged substantially perpendicular to the slits 13. The segmented electrodes may be arranged either substantially parallel or substantially perpendicular relative to that of the respective slits.

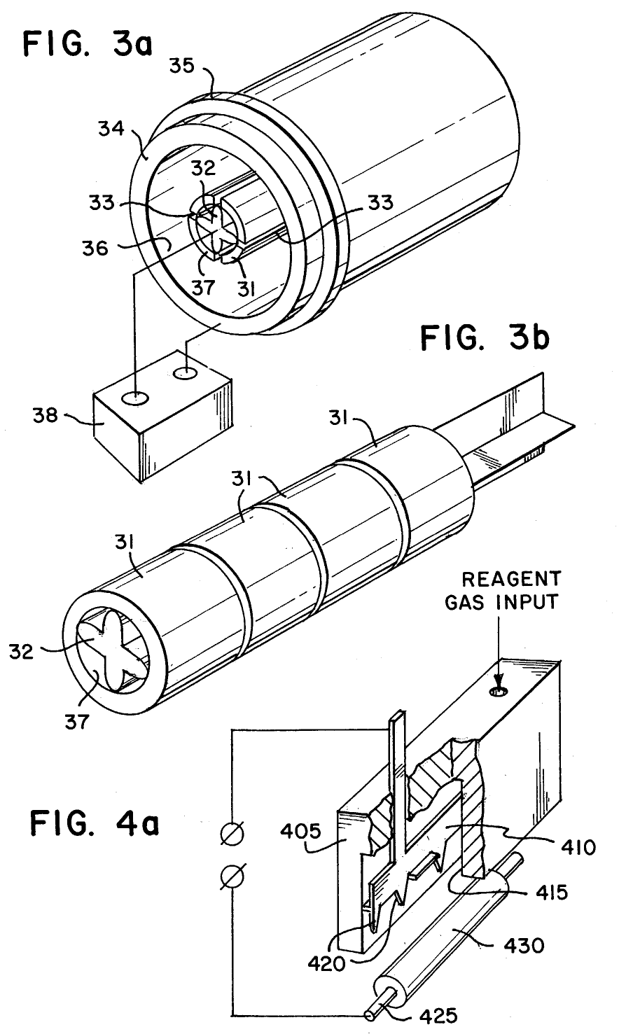

An exemplary third annular or cylindrical embodiment of the non-thermal atmospheric pressure plasma discharge device in accordance with the present invention is shown in FIG. 3a. In this embodiment, the primary dielectric annular tube 31 is longitudinally divided into four radial sections with adjacent sections separated a predetermined distance from one another to form a slit 33 therebetween disposed in a longitudinal axial direction. Segmented electrode 32 comprises four blades disposed to form a star with each blade extending longitudinally through the primary dielectric annular tube 31 and disposed proximate and in fluid communication with a corresponding slit 33. A receiving annular electrode 35 encloses the primary dielectric 31 with a secondary annular dielectric 34 disposed between the primary dielectric and receiving annular electrode 35. The segmented electrode 32 and receiving annular electrode 35 are connected to a power source 38. A channel is formed between the primary and secondary dielectrics 31, 34, respectively, to which the reagent fluid to be treated is received. FIG. 3a shows the primary dielectric 31 divided longitudinally into four radial sections, however, it is contemplated and within the intended scope of the invention to divide the dielectric into any number of two or more sections, that may, but need not necessarily, be of equal size, whereby the segmented electrode 32 will preferably be configured with an equal number of blades as slits 33 in the dielectric. If an AC or RF power source is employed, an aqueous liquid 15 may overflow and cover the inside wall of the receiving electrode, otherwise, in the case of a DC power supply a non-aqueous solution may be used. Such an embodiment is particularly well suited in application as a wet electrostatic precipitator/scrubber/non-thermal plasma discharge device for the treatment of off gases or as a device for decontamination/disinfection of a liquid such as water.

As a modification of the embodiment shown in FIG. 3a, instead of the primary dielectric being divided so as to form longitudinal slits therein, the primary dielectric may be divided laterally into sections thereby separating the inner cylindrical tube into a series of rings 31. FIG. 3b is a perspective view of an exemplary primary dielectric configuration divided laterally into four sections or rings with a slit formed between adjacent sections. This alternative primary dielectric configuration could be substituted in FIG. 3a for the longitudinally oriented slit primary dielectric electrode. In still another embodiment, the slit may be defined as a spiral through the cylindrical shaped dielectric with a wire electrode disposed substantially aligned or crossing over the spiral slit.

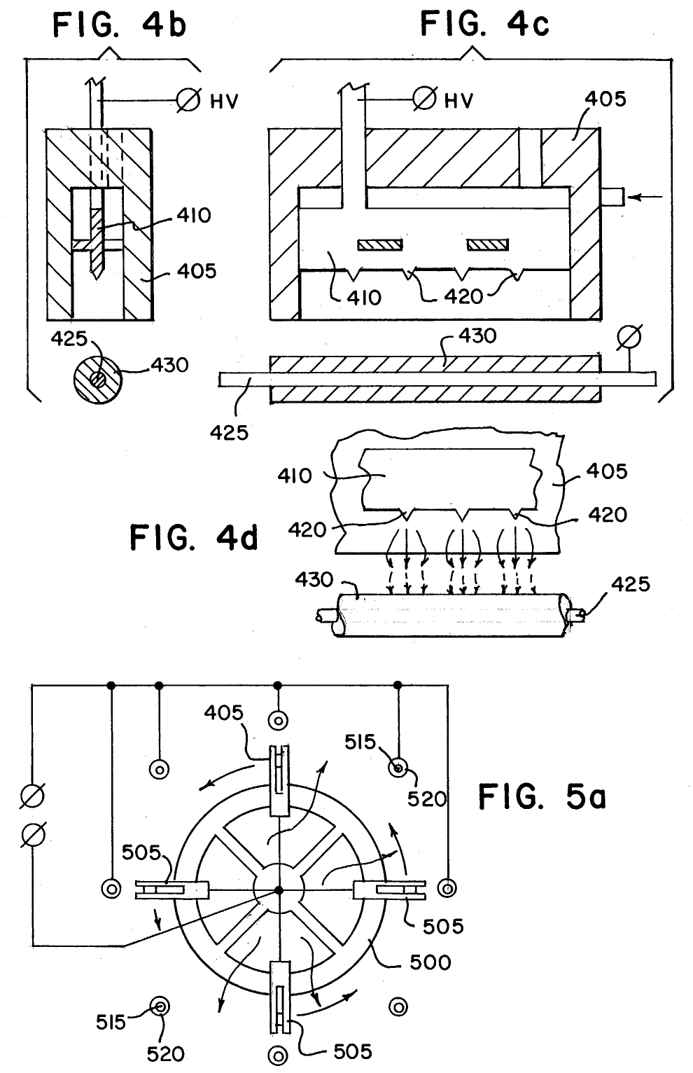

Yet another embodiment of the non-thermal atmospheric pressure plasma discharge device is shown in FIG. 4a. In this configuration a primary dielectric 405 has a portion thereof removed to form a substantially U-shaped lateral cross sectional channel 415. A primary electrode 410 is disposed at least partially within the channel 415. In a preferred embodiment, the primary electrode 410 is a rod or bar having a jagged or sawtooth edge 420 oriented towards the opening of the channel 415. Reagent gas is injected into or passed through the channel 415 and is exposed therein to the non-thermal plasma generated upon applying a voltage differential between the primary electrode 410 and a receiving electrode 425. In the example shown in FIG. 4a, the receiving electrode 425 is an annular cylinder, however other configurations may be substituted, as desired, such as a substantially planar ground electrode plate. A secondary dielectric layer 430 is employed and encases the receiving electrode 425 when an AC or RF power source is used. Alternatively, the receiving electrode 425 may be immersed in a non-conducting liquid. In the case of a DC source the secondary dielectric layer is omitted or the receiving electrode 425 may be immersed in a conducting liquid. FIGS. 4b and 4c show lateral and longitudinal cross-sectional views of the plasma discharge device of FIG. 4a. The teeth of the saw tooth edge of the primary electrode 410 concentrates the high electric field to generate the plasma discharges as shown in FIG. 4d.

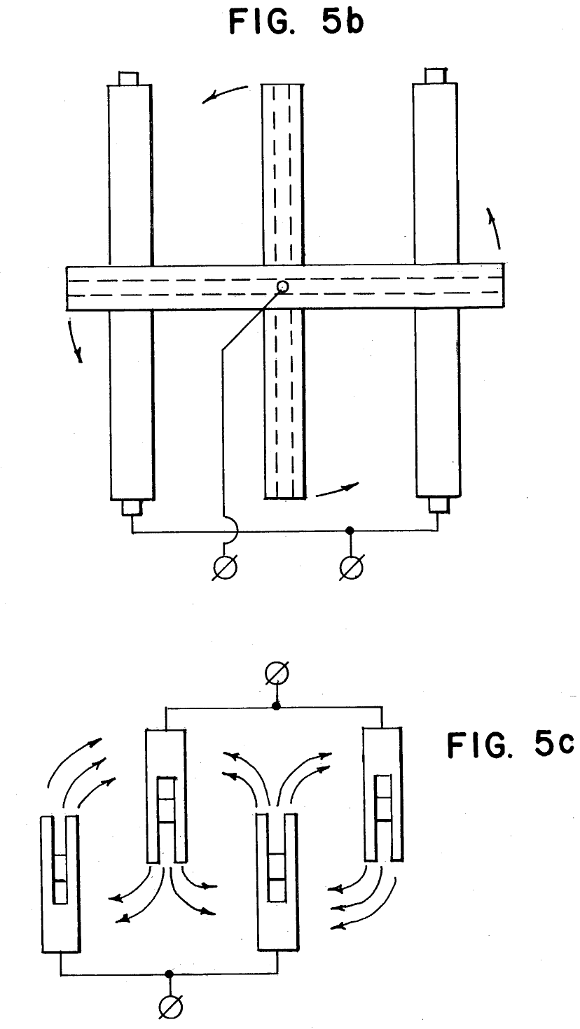

A plurality of non-thermal atmospheric pressure plasma discharge devices 505 having a U-shape configuration as shown in FIG. 4a may be radially positioned about a central rotating wheel 500, as depicted in FIG. 5a. By way of example, four plasma discharge devices 505 are shown positioned approximately 90 degrees from one another with the opening of the U-shaped channel oriented radially outward. The system may be modified to include any number of one or more plasma discharge devices 505 positioned, as desired, about the central rotating wheel and need not be arranged equally distributed with respect to one another. Each plasma discharge device 505 includes a U-shaped primary dielectric with a primary electrode disposed in the U-shaped channel of the primary dielectric, as in FIG. 4a.

One or more receiving electrodes 515 are disposed proximate the central rotating wheel 500 so that a non-thermal plasma discharge is emitted from the plasma discharge device 505 when it is substantially aligned with one of the receiving electrodes. The net effect is a pulsed plasma discharge. Primary and receiving electrodes are connected to a voltage source so as to provide a voltage differential therebetween. In the case of an RF or AC power source the receiving electrodes 515 are encased in a dielectric material 520 or immersed in a non-conducting liquid. As with the previously described embodiments, if a DC power source is employed, no dielectric material 520 is used with respect to the receiving electrode 515. Alternatively, the receiving electrode 515 may be submerged in a conducting liquid.

FIG. 5b is an alternative arrangement wherein two U-shaped dielectric slit configuration plasma discharge devices are mounted substantially perpendicular to one another. Two receiving electrodes are disposed separated a predetermined distance and substantially parallel to a plane defined by the two plasma discharge devices. The plasma discharge devices are arranged with the opening of the U-shaped slits directed towards the receiving electrodes. As the plasma discharge devices rotate relative to the fixed receiving electrodes the plasma discharge zone moves along the region of the plasma discharge device which crosses over the respective receiving electrode.

Previous embodiments shown in FIGS. 5a and 5b depict the plasma discharge devices rotating relative to the receiving electrodes. In the embodiment shown in FIG. 5c, a plurality of U-shaped slit dielectric plasma discharge devices may be arranged offset relative to one another in a stacked offset arrangement. The segmented electrode of one plasma discharge device serves as the receiving electrode for the adjacent plasma discharge device, thereby eliminating the need for a separate receiving electrode. Plasma discharge is indicated by the directional arrows.

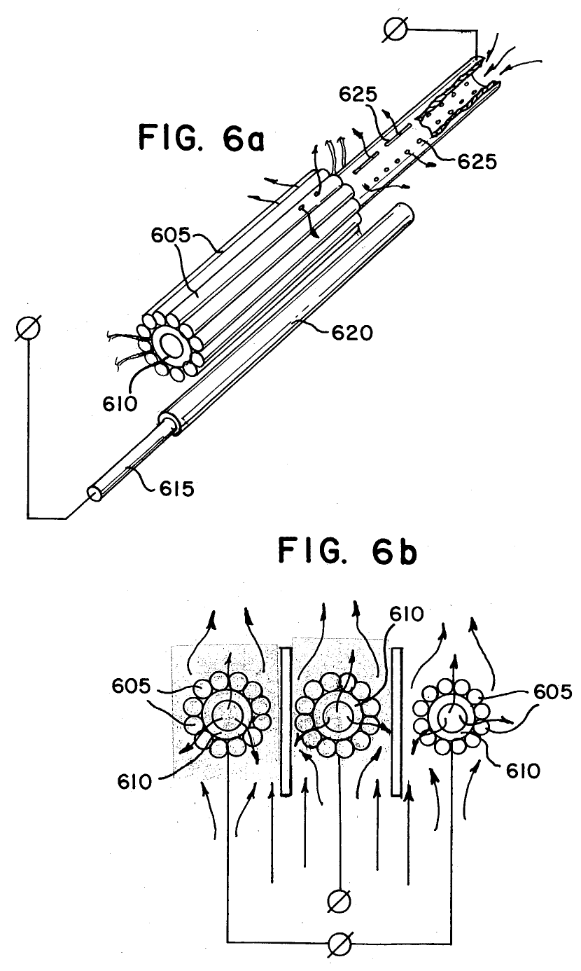

FIG. 6a shows yet another configuration of the non-thermal atmospheric pressure plasma discharge in accordance with the present invention wherein a plurality of dielectric rods 605 are disposed radially about the outer perimeter of an inner cylindrical tube 610, preferably having a hollow center. Twelve rods are disposed about the perimeter of the inner cylindrical tube 610, but the number of rods may be varied, as desired. The inner cylindrical tube 610 may be made from a conductive or a dielectric material. Dielectric rods 605 are arranged to form slits therebetween that allow the passage of a reagent fluid radially outward therefrom. In a preferred embodiment, the slits formed between adjacent dielectric rods have a width less than or equal to approximately 1 mm to obtain the desired choking effect that substantially reduces if not totally eliminates glow-to-arc transitions. In the event that the inner cylindrical tube 610 is made of a dielectric material, conductive wires or rods 625 may be inserted into the slits to act as a primary electrode. A receiving annular cylindrical electrode 615 is disposed proximate the dielectric rods 605 and a voltage differential is applied to the inner cylindrical electrode tube and receiving electrodes 610, 615. Similar to that of the previously described embodiments, if an AC or RF power source is used then the receiving electrode 615 is enclosed in a secondary dielectric layer 620 or immersed in a non-conductive liquid. On the other hand, if a DC source is used the secondary dielectric is not employed and the receiving electrode 615 may be immersed in a conducting liquid. Apertures 625 are defined in the primary electrode 610 to permit the passage of the reagent gas received in the inner hollow channel. Any shape apertures or more than one shape may be used. By way of example, the apertures 625 shown in FIG. 6a are holes and/or slits.

A slightly modified embodiment of the dielectric rod plasma discharge configuration of FIG. 6a is shown in FIG. 6b, wherein a plurality of plasma discharge devices each having a dielectric rod configuration are employed wherein neighboring or adjacent plasma discharge devices are separated by a receiving electrode plate instead of an annular cylindrical receiving electrode (as in FIG. 6a).

Countless other embodiments of the plasma discharge device are contemplated and within the scope of the invention with the underlying concept being that the dielectric is formed as a single integral unit having a plurality of slits (closed on all sides) defined therebetween or a plurality of dielectric segments are assembled together to form slits between adjacent segments (having open ended sides). A plurality of dielectric slit plasma discharge devices can be arranged in a system any number of ways, of which only a few have been described and shown.

The present inventive non-thermal atmospheric pressure plasma discharge apparatus has numerous applications on any media regardless of its state as a solid, liquid or gas. For instance, the plasma discharge device can be used to treat conducting or non-conducting surfaces. Aqueous solutions, non-aqueous solutions or any other liquid may be treated to reduce or eliminate undesirable impurities. In addition, the inventive plasma discharge device can also be used in the treatment of off gases such as automobile exhaust, combustion off gases, and air containing volatile organic compounds (VOCs) and/or other pollutants.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

All patents, patent applications, publications, journal articles, books and other references cited herein are each incorporated by reference in their entirety.

What is claimed is:

1. A plasma reactor comprising:
a primary dielectric having at least one slit defined therein; and
a segmented electrode including a plurality of electrode segments, each electrode segment disposed proximate and in fluid communication with an associated slit.

2. The plasma reactor in accordance with claim 1, wherein the primary dielectric is a substantially planar dielectric plate with the at least one slit defined therethrough forming an open top end an open bottom end and closed walls on all sides.

3. The plasma reactor in accordance with claim 1, wherein the primary dielectric is a substantially U-shaped dielectric plate with a U-shaped channel forming the at least one slit.

4. The plasma reactor in accordance with claim 1, wherein the primary dielectric is a plurality of dielectric segments assembled together so that adjacent dielectric segments are separated by a predetermined distance to form the at least one slit therebetween, adjacent dielectric segments forming walls open on at least one side.

5. The plasma reactor in accordance with claim 4, wherein the plural dielectric segments are in the shape of one of a rod, a bar, a plate, an annular ring, an annular wedge.

6. The plasma reactor in accordance with claim 1, wherein the electrode segments are one of a blade, rod or wire.

7. The plasma reactor in accordance with claim 6, wherein the electrode segments are disposed substantially parallel to respective slits in the primary dielectric.

8. The plasma reactor in accordance with claim 6, wherein the electrode segments are disposed substantially perpendicular to respective slits in the primary dielectric.

9. The plasma reactor in accordance with claim 1, further comprising a receiving electrode disposed proximate the primary dielectric.

10. The plasma reactor in accordance with claim 1, wherein at least a portion of the receiving electrode is covered with a secondary dielectric.

11. The plasma reactor in accordance with claim 1, wherein the electrode segments are at least partially inserted into the respective slits of the primary dielectric.

12. The plasma reactor in accordance with claim 4, wherein the dielectric segments are a dielectric annular tube divided longitudinally into a predetermined number of annular sections, with adjacent sections separated to form a slit therebetween.

13. The plasma reactor in accordance with claim 4, wherein the dielectric segments are a dielectric annular tube divided laterally into a predetermined number of ring sections, with adjacent ring sections separated to form a slit therebetween.

14. The plasma reactor in accordance with claim 1, wherein the segmented electrode has a sawtooth edge.

15. The plasma reactor in accordance with claim 5, wherein the electrode segments are a plurality of electrode rods assembled together to form a slit between adjacent electrode rods.

16. The plasma reactor in accordance with claim 15, wherein the plural electrode rods are disposed about an inner cylindrical tube having a hollow center and apertures defined therethrough.

17. Method for using a plasma reactor including a primary dielectric having at least one slit, and a segmented electrode including a plurality of electrode segments, each electrode segment disposed proximate and in fluid communication with an associated slit, said method comprising the steps of:
applying a voltage differential between the segmented electrode and a receiving electrode disposed proximate the first dielectric to produce a plasma discharge; and
emitting through the slit the generated plasma discharge.
